(19) United States
(12) Patent Application Publication
(10) Pub. No.: US 2007/0039306 A1
(43) Pub. Date: Feb. 22, 2007

(54) Cooling device for generation of a cold gas stream

(76) Inventors: Markus Mayer, Gossau (CH); Jevgeni Guidoulianov, Uster (CH); Roger Durst, Middletown, WI (US)

Correspondence Address: KOHLER SCHMID MOEBUS, RUPPMANNSTRASSE 27, D-70565 STUTTGART, DE

(21) Appl. No.: 11/504,611

(22) Filed: Aug. 16, 2006

(30) Foreign Application Priority Data
Aug. 22, 2005 (DE) 10 2005 039 795.6

(51) Int. Cl. F02G 3/00

(52) U.S. Cl. 60/39.12

(57) ABSTRACT

A cooling device for generating a cold gas flow comprising a gas source and at least one first heat exchanger (4) having a connection (14b) on the input side and a connection (15b) on the output side being cooled using a cold source (10), is characterized in that the cooling device comprises at least one second heat exchanger (5) having a connection (14a) on the input side and a connection (15a) on the output side, wherein the first heat exchanger (4) and the second heat exchanger (5) are disposed in an evacuated container (11) and operate in parallel, the first heat exchanger (4) and the second heat exchanger (5) being connected, via their connections (15a, 15b) on the output side, to a common output line (8) into which they alternately supply the cleaned gas flow. The inventive cooling device may be operated with conventional gases for a long time period without any disturbances.

This application claims Paris Convention priority of DE 10 2005 039 795.6 filed Aug. 22, 2005 the complete disclosure of which is hereby incorporated by reference.

### BACKGROUND OF THE INVENTION

The invention concerns a cooling device for generating a cold gas stream, comprising a gas source and at least one heat exchanger having a connection on the input side and a connection on the output side, which is cooled using a cold source.

A cooling device of this type is disclosed e.g. in JP 2004-069461.

Various analysis methods require cooling of the samples to be analysed. In special cases such as nuclear magnetic resonance spectroscopy or X-ray crystallography, this is effected by disposing the sample in a cold gas stream, preferably a nitrogen or helium gas stream.

This cold gas stream may be realized e.g. through evaporating liquid gases as disclosed in “Cryojet—nitrogen jets for X-ray crystallography” by Oxford Instruments. This involves, however, demanding logistics for providing or generating and storing these liquid gases.

In the method described in JP 2004-069461, the cold gas flow is generated by cooling a warm gas using heat exchangers immersed in liquid gas. Alternatively, the warm gas may also be cooled using refrigerators. Disadvantageously, gas impurities, typically water vapor or carbon dioxide, condense and freeze, thereby clogging the gas-carrying heat exchangers and lines after a certain operating time. In order to prevent formation of ice on the gas-carrying heat exchangers and lines, extremely pure gases are required which can only be obtained with great constructive expense using gas cleaning systems requiring intensive maintenance.

It is therefore the underlying purpose of the present invention to propose a cooling device of simple construction which can be operated without disturbances for a long time period using conventional gases.

### SUMMARY OF THE INVENTION

This object is achieved in accordance with the invention in that the cooling device comprises at least one second heat exchanger having a connection on the input side and a connection on the output side, wherein the first and second heat exchangers are disposed in an evacuated container and operate in parallel, the first and second heat exchangers being connected to a common output line via their connections on the output side, which they alternately supply with a purified gas flow.

The inventive cooling device comprises two heat exchangers which are operated in parallel. In this manner, one of the heat exchangers always supplies a pure gas flow, during the time in which the other heat exchanger is being freed from condensed and frozen impurities through precipitation thereof. The inventive cooling device thereby permits long-term generation of a continuous cooled gas flow. The gas is simultaneously re-cleaned by precipitation of impurities in the heat exchangers. The inventive cooling device may also thereby serve as a gas drying device with an extremely low dew point (to approximately −200° C.).

The connections of the heat exchangers on the output side preferably communicate with each other via a gas container. The gas container, in turn, is connected to the output line and contains the pure gas cooled by the heat exchangers, which can be removed from the gas container for further use. The cooled cleaned gas may e.g. be supplied to the output line to cool a sample, or a cleaned gas may flow through a heat exchanger to be cleaned in a reverse direction in order to remove impurities from the heat exchanger.

At least one of the heat exchangers is provided with a preferably electric heating means, which is advantageous for the cleaning process. The condensed or frozen residual gases are evaporated by heating the corresponding heat exchanger, and can be discharged and removed using a gas flow.

In one advantageous embodiment of the invention, a valve is provided between the gas source and the container, which controls the gas flow to the connections of the heat exchangers on the input side.

In order to bring the cleaned and cooled gas to the exact desired temperature, a further heat exchanger is advantageously provided which is disposed between the first and second heat exchangers and the output line.

A passive cold source, in particular, a cryogenic liquid, e.g. liquid nitrogen, may be provided to cool the heat exchangers.

An active cold source, in particular, a refrigerator, e.g. a pulse tube cooler can also be provided. This is advantageous in that the use of a refrigerator requires no liquid gas which would be expensive to provide, generate and store.

The advantages of the invention can be utilized with particular preference when the cooling device is part of a nuclear magnetic spectroscopy apparatus or X-ray crystallography apparatus, which often require reliable and low-contamination cooling of the sample to be investigated.

The invention also concerns a method for producing a cold cleaned gas flow, wherein a gas flow is supplied from a gas source, via a connection on the input side, to at least one first heat exchanger cooled by a cold source. The gas flow is cooled in the first heat exchanger and supplied to an output line via a connection on the output side, wherein undesired gas particles are frozen out by cooling the gas flow in the first heat exchanger. The first heat exchanger is operated in parallel with at least one second heat exchanger which is cooled by a cryogen, in such a manner that, during a first time period in which the gas flow is supplied from the gas source to the first heat exchanger and the gas flow is cleaned in the first heat exchanger through freezing out undesired gas particles, the second heat exchanger is cleaned by a heating process. In a subsequent second time period, the working modes of the first and second heat exchangers are interchanged, wherein both time periods are cyclically repeated.

Each work cycle consists of two time segments of preferably identical length. In the first time segment, the first heat exchanger is used to cool and supply the pure gas, while the second heat exchanger is being cleaned. In the second time segment, the second heat exchanger is used for cooling and supplying the pure gas, while the first heat exchanger is being cleaned. In order to switch over the operating modes between the two time segments, the direction of the gas flow is changed using a 4/2-way valve. The two heat exchangers thereby always remain at operating temperature and need not be separated from the cold source for precipitating condensed or frozen residual gases.

The cleaned gas flows are preferably collected in a gas container before being supplied into the output line. The cleaned gas may then be removed from this gas container for the desired use.

One of the heat exchangers is preferably cleaned such that, during the heating process, gas flows through the corresponding heat exchanger from the rear: from the connection on the output side to the connection on the input side.

The gas flow used for cleaning the heat exchangers is preferably removed from the gas container, thereby preventing further impurities from getting into the heat exchangers.

In order to permit rapid and individual temperature control of the cleaned gas flow, the cleaned gas flow is advantageously guided through a further heat exchanger before being supplied to the output line, wherein the further heat exchanger controls the temperature of the gas flow to a desired value.

The gas flow from the gas source is preferably controlled via a valve before it enters the evacuated container, the valve being disposed outside of the evacuated container. This obviates the need for a gas flow switching valve that is located in the vacuum container and that must be actuated in cold surroundings, involving all associated disadvantages such as e.g. proper vacuum sealing.

Further advantages of the invention can be extracted from the description and the drawing. The features mentioned above and below may be used individually or collectively in arbitrary combination. The embodiments shown and described are not to be understood as exhaustive enumeration but have exemplary character for describing the invention.

### BRIEF DESCRIPTION OF THE DRAWING

FIG. 1 shows an embodiment of the inventive cooling device for generating a cold cleaned gas flow in a first time segment of an inventive cyclic cooling process.

### DESCRIPTION OF THE PREFERRED EMBODIMENT

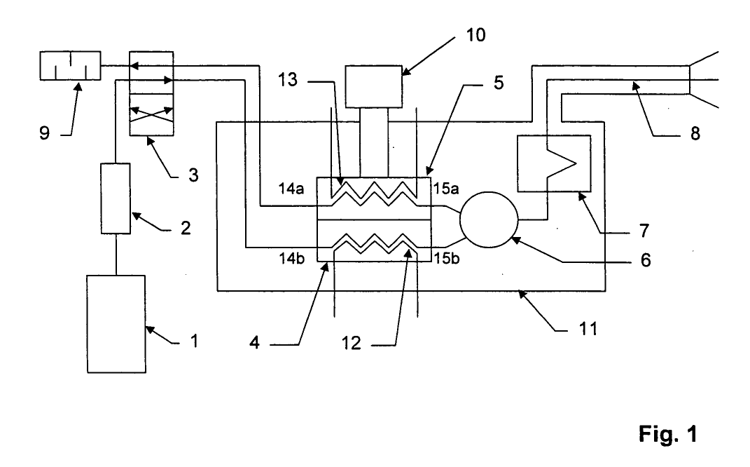

The gas flow through the inventive cooling device shown in FIG. 1 starts with oil-free pressure generation in a compressor 1, continues via a gas separator 2, e.g. a nitrogen separator as described in Module Specification of SEPAREL MJ-G530 by Dainippon ink & chemicals, Inc., Jul. 1, 1997, for separating a certain gas, preferably nitrogen, from compressed air. The gas to be cooled is subsequently alternately guided via a 4/2-way valve 3, in a first time segment, to a connection 14b of a first heat exchanger 4 on the input side and, in a second time segment, to a connection 14a of a second heat exchanger 5 on the input side, in which the gas flow is cooled. Impurities in the gas flow to be cooled are condensed and freeze, thereby simultaneously cleaning the gas flow to be cooled.

The cooled gas is collected in a gas container 6 through connections 15a, 15b of the heat exchangers 4, 5 on the output side, and is heated via a controlled heat exchanger 7 to the desired output temperature, from where it is guided to the location of use, e.g. a sample to be cooled, via a vacuum-insulated output line 8.

Part of the gas in the gas container 6 is alternately guided from the gas container 6 through the first heat exchanger 4 (second time segment) or the second heat exchanger 5 (first time segment) which is not being used for cooling the supplied gas flow during that time segment, back to the valve 3, and blown out through a sound attenuator 9. At the same time, the gas from the gas source is cooled in the other heat exchanger through heat exchange with a cold source 10 which cools the heat exchangers 4, 5. The three heat exchangers 4, 5, 7 and the gas container 6 are disposed in a vacuum container 11 at a cryogenic temperature.

Heating coils 12, 13 are provided for cleaning the heat exchangers 4, 5, which may e.g. be installed in heat exchanger tubes, and are preferably operated with electricity. The electric connections of the heating coils 12, 13 may e.g. be disposed in the gas container 6. Since a heating coil which is preferably loosely inserted into the heat exchanger tube is used for heating, the heat transfer to the heat exchanger is very poor. For this reason, only the gas and frozen residues are mainly heated without noticeably heating the overall heat exchanger and loading the cold source. In particular, the influence on the respective other heat exchanger used for cooling the gas is negligible. The heat exchangers therefore substantially remain at the operating temperature.

FIG. 1 shows an operating state of the inventive cooling device in a first time segment, wherein the first heat exchanger 4 is provided with gas to be cooled from the gas separator 2, and the cleaned gas from the gas container 6 flows from the rear through the second heat exchanger 5. At the same time, the second heat exchanger 5 is heated for a certain time period within this time segment through a heating means 13 disposed in or on the heat exchanger, such that the condensed and frozen impurities are evaporated again and discharged from the heat exchanger, together with the gas flow. This precipitation of impurities prevents clogging of the lines of the heat exchanger 5.

In the second time segment, the function of the two heat exchangers 4, 5 is interchanged, such that one of the heat exchangers 4, 5 generates a cold cleaned gas flow while the other is being freed from impurities.

The inventive cooling device has a particularly simple construction, since valves operating in the cold gas flow are omitted. It is nevertheless possible to ensure a continuous cold gas jet for several thousands of hours, which permits continuous long-term experiments or large series of continuous individual experiments e.g. in nuclear magnetic resonance spectroscopy or X-ray crystallography.

### LIST OF REFERENCE NUMERALS

1 compressor
2 gas separator
3 4/2-way valve
4 first heat exchanger
5 second heat exchanger
6 gas container
7 heat exchanger
8 vacuum-insulated output line
9 sound attenuator
10 cold source
11 vacuum container
12 heating coil
14a connection of the second heat exchanger on the input side
14b connection of the first heat exchanger on the input side
15a connection of the second heat exchanger on the output side
15b connection of the first heat exchanger on the output side

1. A device for producing a cold, cleaned gas flow, the device comprising:
means for connecting a gas flow from a gas source to an input of a first heat exchanger cooled by a cold source;
means for cooling the gas flow to freeze-out undesired components in the gas flow while passing the gas flow to an output of said first heat exchanger communicating with a downstream outlet line;
means for connecting the gas flow from the gas source to an input of a second heat exchanger cooled by said cold source;
means for cooling the gas flow in said second heat exchanger to freeze-out undesired components in the gas flow while passing the gas flow to an output of said second heat exchanger communicating with said downstream outlet line;
means for interrupting gas flow to said first heat exchanger input while the gas flow passes through said second heat exchanger;
means for heating and thereby cleaning said first heat exchanger;
means for re-connecting the gas flow to said first heat exchanger;
means for interrupting gas flow to said second heat exchanger input while the gas flow passes through said first heat exchanger;
means for heating and thereby cleaning said second heat exchanger; and
means for repeated, alternating passage of gas flow through and cleaning of said first and said second heat exchangers.

2. The cooling device of claim 1, further comprising a gas container disposed between and connecting said first and said second heat exchanger outputs to said downstream outlet line.

3. The cooling device of claim 1, wherein at least one of said first and said second heat exchangers comprises an electric heating means.

4. The cooling device of claim 2, wherein a valve is disposed between the gas source and said gas container to control the gas flow to said first and said second heat exchangers inputs.

5. The cooling device of claim 1, further comprising a third heat exchanger disposed between said output line and said first and second heat exchangers.

6. The cooling device of claim 1, wherein said cold source is one of a passive cold source, a cryogenic liquid, and liquid nitrogen.

7. The cooling device of claim 1, wherein said cold source is at least one of an active cold source, a refrigerator, and a pulse tube cooler.

8. The cooling device of claim 1, further comprising means for nuclear magnetic resonance spectroscopy or X-ray crystallography.

9. A method for producing a cold, cleaned gas flow, the method comprising the steps of:
a) connecting a gas flow from a gas source to an input of a first heat exchanger cooled by a cold source;
b) cooling the gas flow in the first heat exchanger to freeze-out undesired components in the gas flow while passing the gas flow to an output of the first heat exchanger communicating with a downstream outlet line;
c) connecting the gas flow from the gas source to an input of a second heat exchanger cooled by the cold source;
d) cooling the gas flow in the second heat exchanger to freeze-out undesired components in the gas flow while passing the gas flow to an output of said second heat exchanger communicating with the downstream outlet line;
e) interrupting gas flow to the first heat exchanger input during steps c) and d);
f) heating and cleaning the first heat exchanger during step e);
g) re-connecting the gas flow to the first heat exchanger to repeat step b);
h) interrupting gas flow to the second heat exchanger input during step g);
i) heating and cleaning the second heat exchanger during step h); and
j) repeating steps c) through i) a plurality of times.

10. The method of claim 9, wherein cleaned gas flows are collected in a gas container before being supplied into the output line.

11. The method of claim 10, wherein, during a heating process, a gas flow passes through one of the first and second heat exchangers from a rear via a connection on an output side to a connection on an input side.

12. The method of claim 11, wherein a gas flow used for cleaning the first and second heat exchanger is removed from the gas container.

13. The method of claim 9, wherein a cleaned gas flow is guided through an additional heat exchanger before being supplied into the output line, wherein the additional heat exchanger controls a temperature of the gas flow to a desired value.

14. The method of claim 9, wherein the gas flow from the gas source is controlled by a valve before entering an evacuated container, the valve being disposed outside of the evacuated container.
